(19) United States
(12) Patent Application Publication
(10) Pub. No.: US 2026/0156622 A1
(43) Pub. Date: Jun. 4, 2026

(54) SYSTEM TIME DETERMINING METHOD AND DEVICE, TIME POSITION INDICATING METHOD AND DEVICE, AND REQUEST TRANSMITTING METHOD AND DEVICE

(71) Applicant: Beijing Xiaomi Mobile Software Co., Ltd., Beijing (CN)

(72) Inventors: Yumin WU, Beijing (CN); Rao SHI, Beijing (CN)

(73) Assignee: Beijing Xiaomi Mobile Software Co., Ltd., Beijing (CN)

(21) Appl. No.: 18/716,727

(22) PCT Filed: Dec. 7, 2021
(86) PCT No.: PCT/CN2021/136071

§ 371 Date: Jun. 5, 2024

(51) Int. Cl. H04W 72/0446; H04L 1/1812; H04W 72/231

(52) U.S. Cl. CPC H04W 72/0446; H04L 1/1812; H04W 72/231

(57) ABSTRACT

The present disclosure relates to methods and apparatuses for system time determining, time position indicating, and request transmitting, where the system time determining method includes: receiving signaling transmitted by a network side device, where the signaling carries reference time information; determining a reference time position associated with the reference time information; and determining the reference time information as a system time of the reference time position.

### CROSS REFERENCE TO RELATED APPLICATIONS

This application is a National Phase of International Application No. PCT/CN2021/136071, filed on Dec. 7, 2021, the entire contents of which are incorporated herein by reference in their entireties.

### TECHNICAL FIELD

The present disclosure relates to the field of communication technology, in particular to system time determining methods and devices, time position indicating methods and devices, request transmitting methods and devices, communication devices, and computer-readable storage media.

### BACKGROUND

In related arts, a network side can indicate system time such as System Frame Number (SFN) or Hyper SFN (H-SFN), etc. to a terminal through system information.

For example, SFN can be carried in a Master Information Block (MIB), where SFN has a total of 10 bits, and a part of the bits are transmitted through a Radio Resource Control (RRC) message corresponding to the MIB, and the other part of the bits is transmitted through a Physical Broadcast Channel (PBCH).

Since the SFN has a total of 10 bits, a maximum value is 1024. When the SFN reaches 1024, the SFN needs to be re-counted, a procedure of which is called number wrapping around. The network side can carry the H-SFN through a System Information Block (SIB) 1, and when the SFN undergoes number wrapping around, the H-SFN is increased by 1.

The way the terminal determines the system time includes that the terminal determines the system time in the received system information as a system time of a time location for receiving the system information. For example, when the terminal receives an MIB at subframe n, an SFN carried in the MIB can be determined as an SFN of a system frame where subframe n is located. Similarly, when the terminal receives an SIB1 at subframe n, an H-SFN carried in the SIB1 can be determined as an H-SFN of a system frame where subframe n is located.

However, a premise for the terminal to determine the system time in the above way is that the network side and the terminal have the same understanding of the system time carried in the system information, that is, they both believe that the system time in the system information is the system time of the time location at which the system information is received. However, in some cases, the network side and the terminal have different understandings of the system time carried in the system information, which is difficult to accurately determine the time location corresponding to the system time carried in the system information.

### SUMMARY

In view of this, the embodiments of the present disclosure provide system time determining methods and devices, time position indicating methods and devices, request transmitting methods and devices, communication devices, and computer-readable storage media, to solve the technical problem in related arts.

According to the first aspect of the embodiments of the present disclosure, a system time determining method is provided, performed by a terminal, including: receiving signaling transmitted by a network side device, where the signaling carries reference time information; determining a reference time position associated with the reference time information; and determining the reference time information as a system time of the reference time position.

According to the second aspect of the embodiments of the present disclosure, a system time determining method is provided, performed by a terminal, including: according to a request of a network side device, receiving system information broadcasted by the network side device, where the system information carries reference time information; determining a receipt time position of the system information as a reference time position associated with the reference time information; and determining the reference time information as a system time of the reference time position.

According to the third aspect of the embodiments of the present disclosure, a time position indicating method is provided, performed by a network side device, including: transmitting signaling to a terminal, where the signaling carries reference time information; and indicating a reference time position associated with the reference time information to the terminal.

According to the fourth aspect of the embodiments of the present disclosure, a request transmitting method is provided, performed by a network side device, including: transmitting a request to a terminal for requesting the terminal to read reference time information in system information broadcasted by the network side device.

According to the fifth aspect of the embodiments of the present disclosure, a system time determining device is provided, including one or more processors configured to: receive signaling transmitted by a network side device, where the signaling carries reference time information; determine a reference time position associated with the reference time information; and determine the reference time information as a system time of the reference time position.

According to the sixth aspect of the embodiments of the present disclosure, a system time determining device is provided, including one or more processors configured to: according to a request of a network side device, receive system information broadcasted by the network side device, where the system information carries reference time information; determine a receipt time position of the system information as a reference time position associated with the reference time information; and determine the reference time information as a system time of the reference time position.

According to the seventh aspect of the embodiments of the present disclosure, a time position indicating device is provided, including one or more processors configured to: transmit signaling to a terminal, where the signaling carries reference time information; and indicate a reference time position associated with the reference time information to the terminal.

According to the eighth aspect of the embodiments of the present disclosure, a request transmitting device is provided, including one or more processors configured to: transmit a request to a terminal for requesting the terminal to read reference time information in system information broadcasted by the network side device.

According to the ninth aspect of the embodiments of the present disclosure, a communication device is provided, including: one or more processors; and one or more memories for storing a computer programs; where when the computer program is executed by the one or more processors, the system time determining method according to any one mentioned above is implemented.

According to the tenth aspect of the embodiments of the present disclosure, a communication device is provided, including: one or more processors; and one or more memories for storing a computer programs; where when the computer program is executed by the one or more processors, the time position indicating method and/or the request transmitting method is implemented.

According to the eleventh aspect of the embodiments of the present disclosure, a computer-readable storage medium for storing a computer program is provided, where when the computer program is executed by one or more processors, the system time determining method according to any one mentioned above is implemented.

According to the twelfth aspect of the embodiments of the present disclosure, a computer-readable storage medium for storing a computer program is provided, where when the computer program is executed by one or more processors, the time position indicating method and/or the request transmitting method is implemented.

According to an embodiment of the present disclosure, when the network side device transmits system information to the terminal through signaling, the network side device further indicates a reference time position associated with the reference time information to the terminal, which ensures that the network side device and the terminal have consistent understanding of the reference time information in the system information. That is, both the network side device and the terminal will determine the reference time information as the system time of the reference time position. Accordingly, it can be ensured that the network side device and the terminal have a consistent understanding of the reference time information in the system information, avoiding problems when the terminal uses the system time for subsequent operations.

According to another embodiment of the present disclosure, in a case where the network side device transmits system information to the terminal through signaling, the network side device may transmit a request to the terminal for requesting the terminal to receive the system information broadcasted by the network side device and read the reference time information in the system information. Since the system information broadcasted by the network side device is updated in real-time, there is not the case where the system information in the signaling is not updated during retransmission. Therefore, it is accurate to determine, according to the reference time information in the broadcasted system information, the system time information of the receipt time location of the system information. Accordingly, it can ensure the accurate determination of the system time information for the receipt time position, avoiding problems when the terminal uses the system time for subsequent operations.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained according to these drawings without creative effort.

FIG. 1 is a schematic flowchart of a system time determining method according to embodiments of the present disclosure.

FIG. 2 is a schematic flowchart of another system time determining method according to embodiments of the present disclosure.

FIG. 3 is a schematic diagram of a relative time position and a receipt time position according to embodiments of the present disclosure.

FIG. 4 is a schematic flowchart of another system time determining method according to embodiments of the present disclosure.

FIG. 5 is a schematic diagram of another relative time position and a receipt time position according to embodiments of the present disclosure.

FIG. 6 is a schematic flowchart of still another system time determining method according to embodiments of the present disclosure.

FIG. 7 is a schematic flowchart of still another system time determining method according to embodiments of the present disclosure.

FIG. 8 is a schematic flowchart of a system time determining method according to embodiments of the present disclosure.

FIG. 9 is a schematic flowchart of still another system time determining method according to embodiments of the present disclosure.

FIG. 10 is a schematic flowchart of still another system time determining method according to embodiments of the present disclosure.

FIG. 11 is a schematic flowchart of still another system time determining method according to embodiments of the present disclosure.

FIG. 12 is a schematic flowchart of a time position indicating method according to embodiments of the present disclosure.

FIG. 13 is a schematic flowchart of another time position indicating method according to embodiments of the present disclosure.

FIG. 14 is a schematic flowchart of a request transmitting method according to embodiments of the present disclosure.

FIG. 15 is a schematic block diagram of a time position indicating device and/or a request transmitting device according to embodiments of the present disclosure.

FIG. 16 is a schematic block diagram of a system time determining device according to embodiments of the present disclosure.

### DETAILED DESCRIPTION

The technical solutions in the embodiments of the present disclosure are clearly described below with reference to the accompanying drawings in the embodiments of the present disclosure. The embodiments described are merely some embodiments of the present disclosure, and not all embodiments. Other embodiments achieved by those skilled in the art according to the embodiments in the present disclosure without paying creative work shall all fall within the scope of protection of the present disclosure.

The term used in the embodiments of the present disclosure is for the purpose of describing particular examples only and is not intended to limit the embodiments of the present disclosure. As used in the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of one or more of the associated listed items.

It shall be understood that, although the terms “first,” “second,” “third,” and the like may be used herein to describe various information, the information should not be limited by these terms. These terms are only used to distinguish the same type of information from each other. For example, without departing from the scope of the present disclosure, first information may be referred as second information; and similarly, second information may also be referred as first information. Depending on the context, the word “if” as used herein can be interpreted as “upon”, “when” or “in response to determining”.

For the purpose of simplicity and ease of understanding, the terms used in the present disclosure to represent comparison are “greater than”, “less than”, “higher than” or “lower than”. But for those skilled in the art, it can be understood that the term “greater than” also encompasses the meaning of “greater than or equal to”, “less than” also encompasses the meaning of “less than or equal to”, “higher than” encompasses the meaning of “higher than or equal to”, and “lower than” also encompasses the meaning of “lower than or equal to”.

In related arts, each time a base station transmits system information, the system information is transmitted as new transmission, and a system time carried by the system information is updated in real-time. For the convenience of explaining the principle, for example, assuming that the time position at which the base station transmits system information is the same as the time position at which the terminal receives the system information (i.e., the difference between the two time positions is ignored).

For example, the base station transmits system information at subframe 1 of a system frame with an SFN being 1024, and the system time carried in the system information is the SFN being 1024. Since the system information transmitted by the base station is new transmission where the system time is updated in real-time, the understanding of the system time carried in the system information is consistent for both the base station and the terminal. That is, for both the base station and the terminal, a reference time position is the same, and the time position at which the system information is received (the same as the time position at which the base station transmits the system information) is determined as the reference time position. The base station will determine 1024 as an SFN of the system frame at which a time location at which the terminal receives the system information is located, and the terminal will also determine 1024 as an SFN of the system frame at which a time location at which the terminal receives the system information is located.

However, in some cases, the system information transmitted by the base station is not new transmission, resulting in the system time carried in the system information not being updated in real-time, which leads to inconsistent understanding between the base station and the terminal regarding the system time carried in the system information.

For example, when the network side device such as a base station detects, by a fake base station, and acknowledges that a terminal has received system information transmitted by the fake base station, or to avoid the terminal receiving broadcast system information during a mobility procedure (such as cell switching), the network side device will transmit system information to the terminal through dedicated signaling, such as RRCReconfiguration signaling through radio resource control to transmit system information to the terminal.

In the case of transmitting system information to the terminal through dedicated signaling, there may be a situation where the terminal does not successfully receive the dedicated signaling, and the network side device needs to retransmit the dedicated signaling. The content of the retransmitted dedicated signaling is the same as the content of dedicated signaling for the first transmission (which can be understood as the new transmission), that is, the system time in the system information carried by the retransmitted dedicated signaling is the same as the system time in the system information carried by the first transmission of the dedicated signaling.

For example, the system time in the system information carried by the first transmission of dedicated signaling is SFN being 1024. When the terminal receives the first transmission of dedicated signaling, the terminal can determine that the SFN of the system frame at which a receipt time location of the first transmission of dedicated signaling is located is 1024. The system time determined this time is correct.

However, for subsequent retransmissions, there may be problems with the determined system time. For example, for a subsequent retransmission, an actual system time for the subsequent retransmission has advanced by one frame relative to the system time for the first transmission, such that the SFN will wrap around to 1, and the H-SFN will also increase by 1. However, since the system time in the system information carried by the retransmitted dedicated signaling is the same as the system time in the system information carried by the first transmission of dedicated signaling, the system time in the system information carried by the retransmitted dedicated signaling is still the SFN 1024, rather than the wrapped SFN 1.

In this case, the understanding of the system time carried in the system information between the network side device and the terminal is inconsistent. The network side device will determine a receipt time position of the first transmission received by the terminal as a reference time position, but the terminal will determine a receipt time position of a current retransmission as a reference time position, resulting in that the network side device determines SFN 1024 as the system time corresponding to the receipt time position of the first transmission received by the terminal, and the terminal determines SFN 1 as the system time corresponding to the receipt time position of the current retransmission received by the terminal, which will cause a series of problems when the terminal uses the system time in the retransmission for subsequent operations, such as Discontinuous Reception (DRX). The embodiments of the present disclosure are mainly proposed to address the technical problems caused by the above situation.

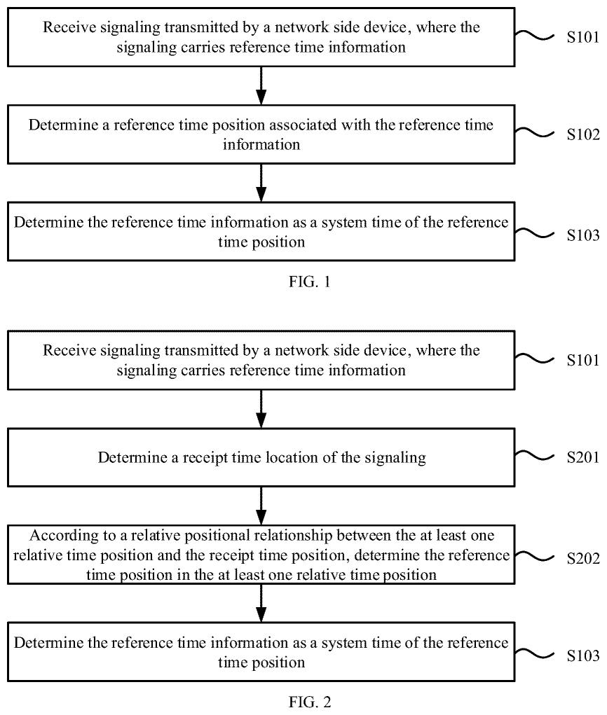

FIG. 1 is a schematic flowchart of a system time determining method according to embodiments of the present disclosure. The system time determining method shown in the embodiments can be performed by a terminal. The terminal includes but is not limited to a communication device such as a mobile phone, a tablet, a wearable device, a sensor, or an Internet of Things (IoT) device. The terminal can communicate with a network side device. The network side device includes but not limited to a network side device (such as a base station, a core network, etc.) in a communication system such as a 4G communication system, a 5G communication system, or a 6G communication system, etc.

As shown in FIG. 1, the system time determining method may include the following steps S101-S103.

In step S101, signaling transmitted by a network side device (such as the dedicated signaling for the retransmission mentioned above) is received, where the signaling carries reference time information.

In step S102, a reference time position associated with the reference time information is determined.

In step S103, the reference time information is determined as a system time of the reference time position.

In an embodiment, when the network side device transmits system information to the terminal through signaling, the system information may carry reference time information. For example, the system information is MIB, and the reference time information is SFN. For example, the system information is SIB1, and the reference time information is H-SFN.

In a case, when the network side device transmits system information to the terminal through signaling, the terminal may not receive the signaling, and the network side device retransmits the signaling. In this case, if the content of the first transmission of signaling is the same as the content of the retransmitted signaling, the reference time information in the first transmission of signaling is the same as the reference time information in the retransmitted signaling. For example, the SFN in the first transmission of signaling is the same as the SFN in the retransmitted signaling, and the H-SFN in the first transmission of signaling is the same as the H-SFN in the retransmitted signaling.

This can lead to inconsistent understanding between the network side device and the terminal regarding the system time carried in the system information. For example, the network side device may determine a receipt time position of the first transmission of signaling received by the terminal as a reference time position, but the terminal may determine a receipt time position of the current retransmitted signaling as a reference time position.

According to the embodiments of the present disclosure, when the network side device transmits system information to the terminal through signaling, the network side device further indicates a reference time position associated with the reference time information to the terminal, which ensures that the network side device and the terminal have consistent understanding of the reference time information in the system information. That is, both the network side device and the terminal will determine the reference time information as the system time of the reference time position. For example, if the reference time information is SFN=1, it can be determined that the SFN of the system frame at which the reference time position is located is 1. Accordingly, it can be ensured that the network side device and the terminal have a consistent understanding of the reference time information in the system information, avoiding problems when the terminal uses the system time for subsequent operations.

In an embodiment, the terminal may determine a resource for receiving the signaling according to configuration information transmitted by the network side device, where the configuration information includes at least one of the following:

time-domain resource configuration; or frequency-domain resource configuration.

The time-domain resource configuration can include at least one of the following:

a start time position (e.g., SFN=1, subframe=1, slot=1);

a transmitting period (e.g., 10 milliseconds); or

a transmission time location in each period (such as slot 1, slot 3, slot 5 in every 10 time slots).

The frequency-domain resource configuration can include at least one of the following:

frequency (such as ARFCN-1 (Absolute Radio Frequency Channel Number);

a bandwidth (e.g., 20 MHz);

a physical resource block number (e.g., PRB-1 (Physical Resource Block));

a bandwidth part number (e.g., BWP-1 (Bandwidth Part)); or

a cell number (e.g., cell-1).

In an embodiment, the reference time position is determined by a network side configuration or according to a protocol agreement.

The way for determining the reference time position associated with the reference time information can be determined according to a protocol agreement. In this case, the terminal and the network side device can respectively obtain the way for determining the reference time position according to the protocol agreement. The way for determining the reference time position associated with the reference time information can also be configured by the network side device. In this case, the network side device can set the way for determining the reference time position according to needs, and then configure the determined way to the terminal.

The way for determining the reference time position is not unique. The following examples illustrate several ways for determining the reference time position.

FIG. 2 is a schematic flowchart of another system time determining method according to embodiments of the present disclosure. As shown in FIG. 2, the reference time position corresponds to at least one relative time position, and determining the reference time position associated with the reference time information includes steps S201-S202.

In step S201, a receipt time location of the signaling is determined.

In step S202, according to a relative positional relationship between the at least one relative time position and the receipt time position, the reference time position is determined in the at least one relative time position.

In an embodiment, the way for determining the reference time position may include determining the reference time position according to a relative positional relationship between the receipt time position and a relative time position.

A time in a communication system is generally not a conventional absolute time position. For example, a conventional time position is represented in a time unit such as day, month, year, hour, minute, or second, etc., while a time in a communication system is represented by a system frame and a subframe in the system frame. For example, a system frame has a duration of 10 milliseconds, and includes 10 subframes from subframe 0 to subframe 9.

Therefore, the reference time position indicated by the network side device is not an absolute time, but a time in a communication system. The granularity of the indicated reference time position can be set according to needs. For example, the granularity can be subframe, such as subframe 2 as a reference time position. For example, the granularity can be slot, such as slot 1 of subframe 2 as a reference time position. The following embodiments are mainly described with the granularity being subframe as examples.

Since the reference time position is the time in the communication system, such as the subframe and there are 10 subframes in each system frame, a reference time position corresponds to at least one relative time position, where relative time positions are time positions in multiple system frames for the reference time position. The multiple system frames can be defined according to needs, such as all system frames or system frames within a certain time range.

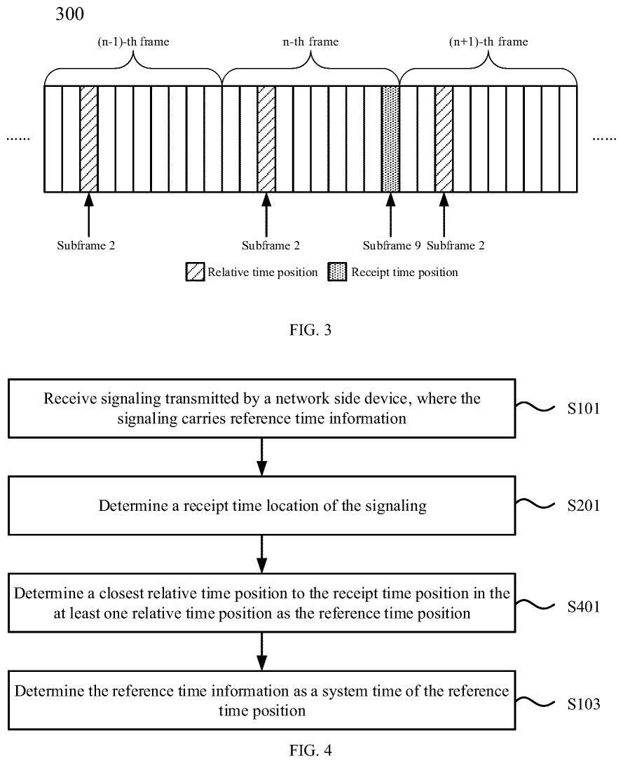

FIG. 3 is a schematic diagram 300 of a relative time position and a receipt time position according to embodiments of the present disclosure. As shown in FIG. 3, for example, if the reference time position is subframe 2, the relative time positions include multiple subframes 2 in multiple system frames. For example, if the system frame at which the receipt time position is located is the n-th frame of the system frames, the previous (n−1)-th frame of the system frames, the next (n+1)-th frame of the system frames, and the n-th frame of the system frames all include a subframe 2, and the multiple subframes 2 are the relative time positions for the reference time position. It should be noted that FIG. 3 only shows the relative time positions in three adjacent system frames. In practice, there can be more relative time positions, which are not shown in the figures.

It should be noted that n-th, (n+1)-th, and (n−1)-th in the n-th, (n+1)-th, and (n−1)-th frames do not indicates system times, but are used to indicate consecutive system frames. The system times, such as SFN and H-SFN, of these system frames is unknown to the terminal, but the terminal can determine a sequence number of a subframe in a system frame.

When a reference time position is in different system frames, since a relationship between the reference time position in different system frames and the receipt time position varies, a relationship between each relative time position and the receipt time position is different. For example, if the receipt time position is subframe 9, subframe 2 in the (n+1)-th frame is located after the subframe 9, subframe 2 in the (n−1)-th frame is located before the subframe 9, subframe 2 in the n-th frame is located in the same system frame as the subframe 9, and subframe 2 in the (n+1)-th and (n−1)-th frames and subframe 9 are located in different system frames. Therefore, the reference time position can be determined according to a relative positional relationship between the receipt time position and a relative time position.

There can also be multiple ways to determine the reference time position according to the relative positional relationship between the receipt time position and a relative time position, which is described in the following embodiments.

FIG. 4 is a schematic flowchart of another system time determining method according to embodiments of the present disclosure. As shown in FIG. 4, according to the relative positional relationship between the at least one relative time position and the receipt time position, determining the reference time position in the at least one relative time position includes step S401.

In step S401, a closest relative time position to the receipt time position in the at least one relative time position is determined as the reference time position.

In an embodiment, the closest relative time position in multiple relative time positions to the receipt time position can be determined as the reference time position.

For example, in the case shown in FIG. 3, the receipt time position is subframe 9 in the n-th frame, and the multiple relative time positions corresponding to the reference time position are subframe 2 in each system frame. For the subframes 2 in these system frames, the subframes 2 in the n-th frame, and the (n+1)-th frame are relatively close to subframe 9 in the n-th frame, and are most likely to be used as the reference time position. Therefore, subframes 2 in these two system frames can be mainly considered.

After calculation, it can be determined that subframe 2 in the n-th frame to subframe 9 in the n-th frame are 7 subframes apart, and subframe 2 in the (n+1)-th frame to subframe 9 in the n-th frame are 3 subframes apart. Therefore, the closest subframe 2 to the subframe 9 in the n-th frame in the subframes 2 in the multiple system frames is subframe 2 in the (n+1)-th frame. Therefore, subframe 2 in the (n+1)-th frame can be determined as the reference time position, and the reference time information can be determined as the system time of the reference time position.

For example, if the reference time information is SFN, the reference time information is determined as the SFN of the system frame where the reference time position is located. For example, according to the above embodiment, when subframe 2 in the (n+1)-th frame is the reference time position, the reference time information can be determined as the system time of the system frame (i.e., the (n+1)-th frame) at which subframe 2 in the (n+1)-th frame is located. For example, if the reference time information is SFN=1, it can be determined that an SFN of a next system frame after the system frame at which the receipt time position is located is 1.

To provide a clearer explanation of the embodiment, another embodiment is provided below for further explanation.

FIG. 5 is a schematic diagram 500 of another relative time position and a receipt time position according to embodiments of the present disclosure. As shown in FIG. 5, for example, the reference time position is still subframe 2, but the receipt time position is subframe 1 in the n-th frame. In this case, subframe 2 in the (n−1)-th frame is 9 subframes away from subframe 1 in the n-th frame, subframe 2 in the n-th frame is 1 subframe away from subframe 1 in the n-th frame, and subframe 2 in the (n+1)-th frame is 11 subframes away from subframe 1 in the n-th frame. That is, subframe 2 in the n-th frame is closest to the receipt time position. Therefore, it can be determined that subframe 2 in the n-th frame is the reference time position, and the reference time information can be determined as the system time of the system frame (i.e., the n-th frame) at which subframe 2 in the n-th frame is located. For example, if the reference time information is SFN=1, it can be determined that the SFN of the system frame at which the receipt time position is located is 1.

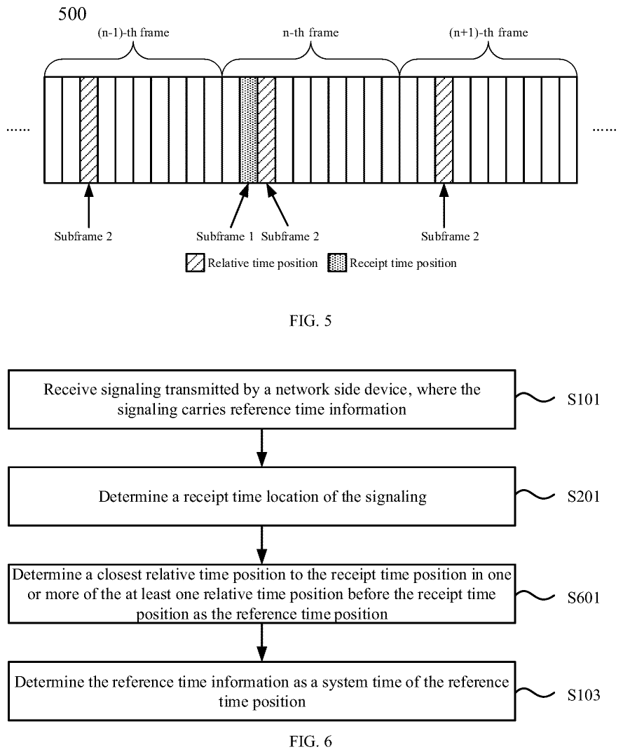

FIG. 6 is a schematic flowchart of still another system time determining method according to embodiments of the present disclosure. As shown in FIG. 6, according to the relative positional relationship between the at least one relative time position and the receipt time position, determining the reference time position in the at least one relative time position includes step S601.

In step S601, a closest relative time position to the receipt time position in one or more of the at least one relative time position before the receipt time position is determined as the reference time position.

In an embodiment, relative time positions before the receipt time position can be determined among the multiple relative time positions, and then the closest relative time position to the receipt time position in the relative time positions before the receipt time position can be determined as the reference time position.

For example, in the case shown in FIG. 3, the receipt time position is subframe 9 in the n-th frame, and multiple relative time positions corresponding to the reference time position are subframe 2 in each system frame. In these subframes 2, the subframes 2 before the subframe 9include subframes 2 in the n-th frame and the system frame(s) before the n-th frame.

After calculation, it can be determined that in subframes 2 located before subframe 9 in the n-th frame, the closest subframe 2 to subframe 9 in the n-th frame is subframe 2 in the n-th frame. Therefore, subframe 2 in the n-th frame can be determined as the reference time position, and the reference time information can be determined as the system time of the reference time position.

For example, if the reference time information is SFN, the reference time information is determined as the SFN of the system frame where the reference time position is located. For example, according to the above embodiment, when subframe 2 in the n-th frame is the reference time position, the reference time information can be determined as the system time of the system frame (i.e., the n-th frame) at which subframe 2 in the n-th frame is located. For example, if the reference time information is SFN=1, it can be determined that the SFN of the system frame at which the receipt time position is located is 1.

To provide a clearer explanation of the embodiment, another embodiment is provided below for further explanation.

For example, in the case shown in FIG. 5, for example, the reference time position is still subframe 2, but the receipt time position is subframe 1 in the n-th frame. In this case, in these subframes 2, subframes 2 located before subframe 1 in the n-th frame include subframes 2 in the (n−1)-th frame and the system frame(s) before the (n−1)-th frame, in subframes 2 located before the subframe 1, subframe 2 in the (n−1)-th frame is closest to subframe 1 in the n-th frame. Therefore, subframe 2 in the (n−1)-th frame can be determined as the reference time position, and the reference time information can be determined as the system time of the system frame (i.e., the (n−1)-th frame) at which subframe 2 in the (n−1)-th frame is located. For example, if the reference time information is SFN=1, it can be determined that an SFN of a previous system frame before the system frame at which the receipt time position is located is 1.

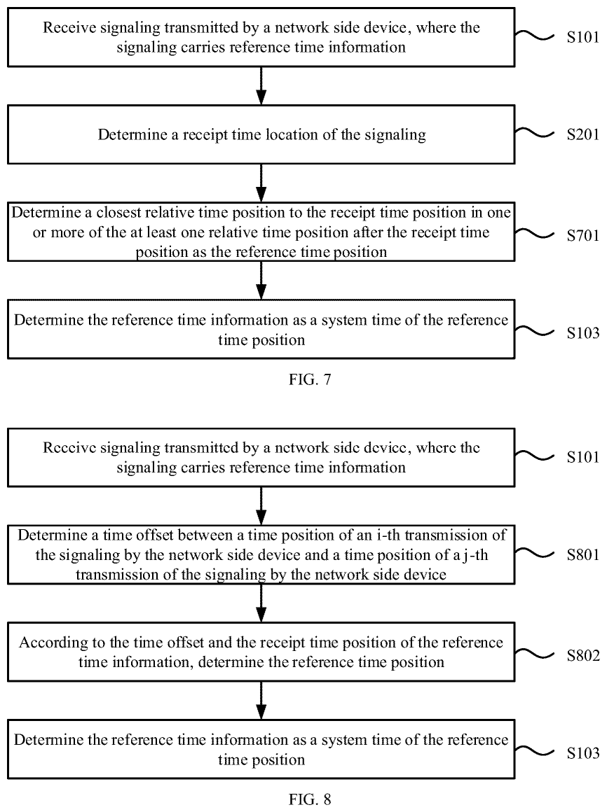

FIG. 7 is a schematic flowchart of still another system time determining method according to embodiments of the present disclosure. As shown in FIG. 7, according to the relative positional relationship between the at least one relative time position and the receipt time position, determining the reference time position in the at least one relative time position includes step S701.

In step S701, a closest relative time position to the receipt time position in one or more of the at least one relative time position after the receipt time position is determined as the reference time position.

In an embodiment, relative time positions after the receipt time position can be determined among the multiple relative time positions, and then the closest relative time position to the receipt time position in the relative time positions after the receipt time position can be determined as the reference time position.

For example, in the case shown in FIG. 3, the receipt time position is subframe 9 in the n-th frame, and multiple relative time positions corresponding to the reference time position are subframe 2 in each system frame. In these subframes 2, the subframes 2 after the subframe 9 include subframes 2 in the (n+1)-th frame and the system frames after the (n+1)-th frame.

After calculation, it can be determined that in these subframes 2 located after subframe 9in the n-th frame, subframe 2 in the (n+1)-th frame is closest to subframe 9 in the n-th frame. Therefore, subframe 2 in the (n+1)-th frame can be determined as the reference time position, and the reference time information can be determined as the system time of the reference time position.

For example, if the reference time information is SFN, the reference time information is determined as the SFN of the system frame where the reference time position is located. For example, according to the above embodiment, when subframe 2 in the (n+1)-th frame is the reference time position, the reference time information can be determined as the system time of the system frame (i.e., the (n+1)-th frame) at which subframe 2 in the (n+1)-th frame is located. For example, if the reference time information is SFN=1, it can be determined that an SFN of a next system frame after the system frame at which the receipt time position is located is 1.

To provide a clearer explanation of the embodiment, another embodiment is provided below for further explanation.

For example, in the case shown in FIG. 5, for example, the reference time position is still subframe 2, but the receipt time position is subframe 1 in the n-th frame. In this case, in these subframes 2, subframes 2 located after subframe 1 in the n-th frame include subframes 2 in the n-th frame and the system frames after the n-th frame, in subframes 2 located after the subframe 1, subframe 2 in the n-th frame is closest to subframe 1 in the n-th frame. Therefore, subframe 2 in the n-th frame can be determined as the reference time position, and the reference time information can be determined as the system time of the system frame (i.e., the n-th frame) at which subframe 2 in the n-th frame is located. For example, if the reference time information is SFN=1, it can be determined that the SFN of the system frame at which the receipt time position is located is 1.

FIG. 8 is a schematic flowchart of still another system time determining method according to embodiments of the present disclosure. As shown in FIG. 8, the network side device transmits the signaling to the terminal n times, and determining the reference time position associated with the reference time information includes steps S801-S802.

In step S801, a time offset between a time position of an i-th transmission of the signaling by the network side device and a time position of a j-th transmission of the signaling by the network side device is determined, where i, j, and n are respectively integers, 1≤i≤n, 1≤j ≤n, and i is greater than or equal to j; and

In step S802, according to the time offset and the receipt time position of the reference time information, the reference time position is determined.

In an embodiment, the reference time position can be determined according to the time offset and the receipt time position. First, a time (i.e., the time position of the i-th transmission) for the i-th transmission of the signaling by the network side device can be determined, and a time (i.e., the time position of the j-th transmission) for the j-th transmission of the signaling by the network side device can be determined. Then, the time-domain length between the time position of the i-th transmission and the time position of the j-th transmission can be determined as the time offset.

In an embodiment, for the terminal, at least one of the i-th transmission or the j-th transmission can be received, or neither can be received.

If the terminal fails to receive at least one of the i-th transmission or the j-th transmission, the network side device needs to indicate the time offset to the terminal. If the terminal receives the i-th and j-th transmissions, the terminal can independently calculate and determine the time offset, or determine the time offset according to a network instruction.

In an embodiment, when the terminal receives the i-th transmission, the i-th transmission can be a current transmission received by the terminal, and the j-th transmission can be a transmission before the current transmission. For example, the j-th transmission can be the previous transmission before the current transmission.

The terminal can subtract the time offset from the receipt time position, and the difference obtained can be determined as a reference time position. For example, if the receipt time position is subframe 9 in the n-th frame, and the time offset is 5 subframes, the reference time position can be determined as subframe 4 in the n-th frame. Therefore, the reference time information can be determined as the system time of the system frame (i.e., the n-th frame) at which subframe 4 in the n-th frame is located. For example, if the reference time information is SFN=1, it can be determined that the SFN of the system frame at which the receipt time position is located is 1.

In an embodiment, a transmission type corresponding to the signaling transmitted by the network side device to the terminal includes at least one of:

hybrid automatic repeat request (HARQ) transmission;

radio link control (RLC) transmission; or

packet data convergence protocol (PDCP) transmission.

The network side device can retransmit signaling to the terminal, which can be a retransmission of HARQ, RLC, or PDCP.

In an embodiment, the time offset is carried in at least one of:

downlink control information (DCI);

media access control (MAC) subheader;

media access control control element (MAC CE);

PLC subheader;

RLC control packet;

packet data convergence protocol (PDCP) subheader; or

PDCP control packet.

Taking the DCI carrying the time offset as an example, the terminal receives the signaling according to the DCI scheduling, for example, the receipt time position of the signaling is subframe 1, the reference time information carried by the system information in the signaling is SFN=1, and the time offset carried by the DCI is 2 subframes. Accordingly, it can be calculated that the reference time position is subframe 9 of the previous system frame before the system frame at which the receipt time position is located. Therefore, it can be determined that the SFN of the previous system frame before the system frame at which the receipt time position is located is 1.

Taking the RLC subheader carrying the time offset as an example, the receipt time position of the signaling received by the terminal is subframe 1, the reference time information carried by the system information in the signaling is SFN=1, and the time offset carried by the RLC subheader is 12 subframes. Accordingly, it can be calculated that the reference time position is subframe 9 of the system frame of previous two before the system frame at which the receipt time position is located. Therefore, it can be determined that the SFN of the system frame of previous two before the system frame at which the receipt time position is located is 1.

In an embodiment, the time offset is carried in an m-th transmission of the signaling, where m is an integer greater than or equal to 1. The time offset can be carried not only in the above information, but also in the m-th transmission of the signaling. When m is equal to 1, the m-th transmission is a new transmission, and the time offset can be 0. When m is greater than 1, the m-th transmission is a retransmission, and the time offset can be greater than 0.

Furthermore, since the time offset is used to determine the reference time position, and the determination of the reference time position is due to the inconsistent understanding of the reference time information between the network side and the terminal side, which generally exists in the case of retransmission of signaling, the time offset can only be carried in the retransmission of signaling, and the time offset is not carried in the new transmission of signaling, which is beneficial for resource conservation.

In an embodiment, information carrying the reference time position includes undivided signaling carrying the reference time position.

The signaling carrying the reference time position may be divided into multiple packets when transmitted from higher to lower layers, for example, in the RLC layer, the signaling may be divided into multiple packets, where each packet contains only partial information of the reference time position, which may result in the information carrying the reference time position carrying only partial information of the reference time position.

Additionally, for a 10-bit SFN, the system information in the signaling may only carry a 6 bit Most Significant Bit (MSB) in the 10-bit SFN.

Both of the above cases can lead to inaccurate determination of the reference time position according to partial information of the reference time position. Therefore, information carrying the reference time position can be set to include undivided signaling (such as a complete 10-bit SFN) carrying the reference time position, such that a complete reference time position can be obtained from the information carrying the reference time position, and the reference time position can be accurately determined.

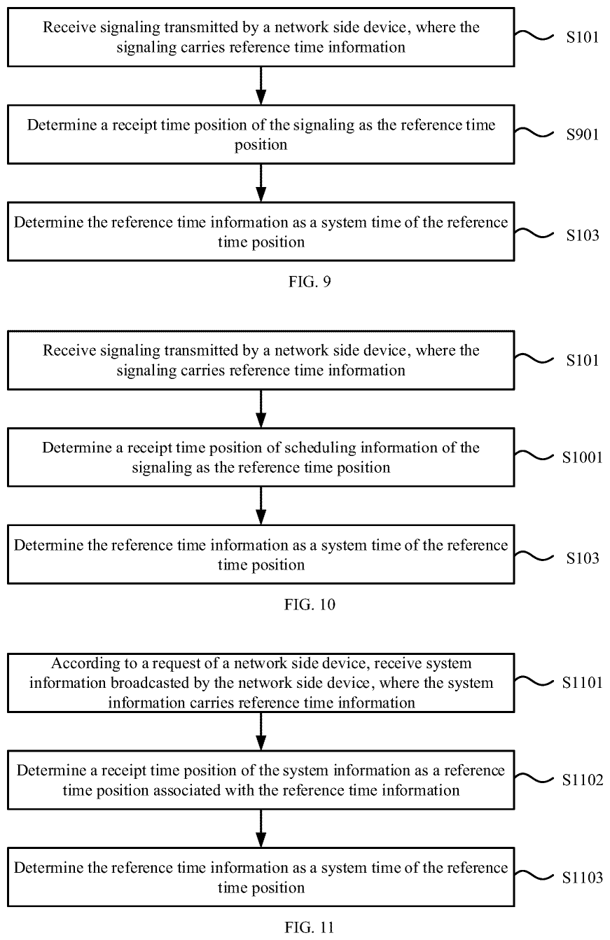

FIG. 9 is a schematic flowchart of still another system time determining method according to embodiments of the present disclosure. As shown in FIG. 9, determining the reference time position associated with the reference time information includes steps S901.

In step S901, a receipt time position of the signaling is determined as the reference time position.

In an embodiment, the terminal can determine the receipt time position of the received signaling as a reference time position, and the reference time information can be determined as the system time of the receipt time position.

In this case, the terminal receives the signaling transmitted by the network side multiple times, and receipt time positions of receiving the signaling for the multiple times are in a same system frame.

If the receipt time positions of the signaling received for the multiple times are not in the same system frame, for example, taking two times as an example, if the receipt time positions for these two times are not in the same system frame, there may be a problem of determining the system time of one system frame as the system time of another system frame.

Therefore, by configuration to enable the terminal to receive the signaling transmitted multiple times by the network side, and to enable the receipt time positions of the signaling received multiple times to be in the same system frame, that is, to enable the network side device to transmit the signaling multiple times, but to enable each transmission to be in the same system frame, it can be ensured that the receipt time positions of the signaling received by the terminal every time are in the same system frame, without crossing system frames, thus avoiding the above problems.

FIG. 10 is a schematic flowchart of still another system time determining method according to embodiments of the present disclosure. As shown in FIG. 10, determining the reference time position associated with the reference time information includes steps S1001.

In step S1001, a receipt time position of scheduling information of the signaling is determined as the reference time position.

In an embodiment, the receipt time position of the scheduling information of the signaling can be scheduled as the reference time position, and the reference time information can be determined as the system time of the receipt time position. For example, if the scheduling information is DCI, the receipt time location of receiving the DCI can be determined.

In this case, transmission carrying the signaling by the network side device is new transmission. Since the scheduling information and the new transmission are generally located in the same system frame, that is, for the new transmission, in this embodiment, the receipt time position of the scheduling information for scheduling the new transmission can be determined as the reference time position. Accordingly, it can be ensured that the receipt time position of scheduling information and the receipt time position of the new transmission are located in the same system frame, thus the receipt time position of scheduling information is determined as the reference time position, which is equivalent to determining the receipt time position of the new transmission as the reference time position, such that there will be no problems.

FIG. 11 is a schematic flowchart of still another system time determining method according to embodiments of the present disclosure. As shown in FIG. 11, the method further includes steps S1101-S1103.

In step S1101, according to a request of a network side device, system information broadcasted by the network side device is received, where the system information carries reference time information.

In step S1102, a receipt time position of the system information is determined as a reference time position associated with the reference time information.

In step S1103, the reference time information is determined as a system time of the reference time position.

In an embodiment, when the network side device transmits system information to the terminal through signaling, the terminal may not receive the signaling, and the network side device retransmits the signaling. In this case, if the content of the first transmission of signaling is the same as the content of the retransmitted signaling, the reference time information in the first transmission of signaling is the same as the reference time information in the retransmitted signaling. For example, the SFN in the first transmission of signaling is the same as the SFN in the retransmitted signaling, and the H-SFN in the first transmission of signaling is the same as the H-SFN in the retransmitted signaling.

This can lead to inconsistent understanding between the network side device and the terminal regarding the system time carried in the system information. For example, the network side device may determine a receipt time position of the first transmission of signaling received by the terminal as a reference time position, but the terminal may determine a receipt time position of the current retransmitted signaling as a reference time position.

According to embodiments of the present disclosure, in a case where the network side device transmits system information to the terminal through signaling, the network side device may transmit a request to the terminal for requesting the terminal to receive the system information broadcasted by the network side device and read the reference time information in the system information. Since the system information broadcasted by the network side device is updated in real-time, there is not the case where the system information in the signaling is not updated during retransmission. Therefore, it is accurate to determine, according to the reference time information in the broadcasted system information, the system time information of the receipt time location of the system information. Accordingly, it can ensure the accurate determination of the system time information for the receipt time position, avoiding problems when the terminal uses the system time for subsequent operations.

For example, after receiving system information according to a request, the terminal can determine the receipt time position of the system information, and then determine the system time position as the reference time position associated with the reference time information, and then determine the reference time information as the system time of the reference time position. For example, if the reference time information is SFN=1, it can be determined that the SFN of the system frame at which the reference time position is located is 1.

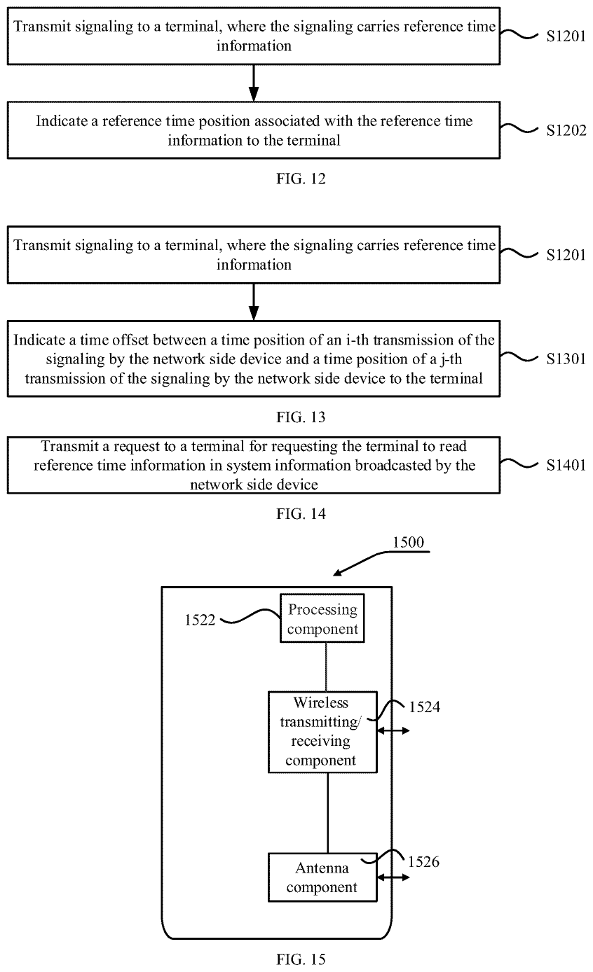

FIG. 12 is a schematic flowchart of a time position indicating method according to embodiments of the present disclosure. The time position indicating method shown in this embodiment can be performed by a network side device, which includes but is not limited to a network side device in a communication system such as 4G, 5G, or 6G communication system, etc., such as a base station, or a core network, etc. The network side device can communicate with the terminal. The terminal includes but is not limited to a communication device such as a mobile phone, a tablet, a wearable device, a sensor, or an Internet of Things (IoT) device.

As shown in FIG. 12, the time position indicating method may include the following steps S1201 and S1202.

In step 1201, signaling is transmitted to a terminal, where the signaling carries reference time information.

In step 1202, a reference time position associated with the reference time information is indicated to the terminal.

In an embodiment, when the network side device transmits system information to the terminal through signaling, the system information may carry reference time information. For example, the system information is MIB, and the reference time information is SFN. For example, the system information is SIB1, and the reference time information is H-SFN.

In a case, when the network side device transmits system information to the terminal through signaling, the terminal may not receive the signaling, and the network side device retransmits the signaling. In this case, if the content of the first transmission of signaling is the same as the content of the retransmitted signaling, the reference time information in the first transmission of signaling is the same as the reference time information in the retransmitted signaling. For example, the SFN in the first transmission of signaling is the same as the SFN in the retransmitted signaling, and the H-SFN in the first transmission of signaling is the same as the H-SFN in the retransmitted signaling.

This can lead to inconsistent understanding between the network side device and the terminal regarding the system time carried in the system information. For example, the network side device may determine a receipt time position of the first transmission of signaling received by the terminal as a reference time position, but the terminal may determine a receipt time position of the current retransmitted signaling as a reference time position.

According to the embodiments of the present disclosure, when the network side device transmits system information to the terminal through signaling, the network side device further indicates a reference time position associated with the reference time information to the terminal, which ensures that the network side device and the terminal have consistent understanding of the reference time information in the system information. That is, both the network side device and the terminal will determine the reference time information as the system time of the reference time position. For example, if the reference time information is SFN=1, it can be determined that the SFN of the system frame at which the reference time position is located is 1. Accordingly, it can be ensured that the network side device and the terminal have a consistent understanding of the reference time information in the system information, avoiding problems when the terminal uses the system time for subsequent operations.

FIG. 13 is a schematic flowchart of another time position indicating method according to embodiments of the present disclosure. As shown in FIG. 13, the network side device transmits the signaling to the terminal n times, and indicating the reference time position associated with the reference time information to the terminal includes a step S1301.

In step S1301, a time offset between a time position of an i-th transmission of the signaling by the network side device and a time position of a j-th transmission of the signaling by the network side device is indicated to the terminal, where i, j, and n are respectively integers, 1≤i≤n, 1≤j≤n, and i is greater than or equal to j.

In an embodiment, the reference time position can be determined according to the time offset and the receipt time position. First, a time (i.e., the time position of the i-th transmission) for the i-th transmission of the signaling by the network side device can be determined, and a time (i.e., the time position of the j-th transmission) for the j-th transmission of the signaling by the network side device can be determined. Then, the time-domain length between the time position of the i-th transmission and the time position of the j-th transmission can be determined as the time offset.

In an embodiment, for the terminal, at least one of the i-th transmission or the j-th transmission can be received, or neither can be received.

If the terminal fails to receive at least one of the i-th transmission or the j-th transmission, the network side device needs to indicate the time offset to the terminal. If the terminal receives the i-th and j-th transmissions, the terminal can independently calculate and determine the time offset, or determine the time offset according to a network instruction.

In an embodiment, when the terminal receives the i-th transmission, the i-th transmission can be a current transmission received by the terminal, and the j-th transmission can be a transmission before the current transmission. For example, the j-th transmission can be the previous transmission before the current transmission.

The terminal can subtract the time offset from the receipt time position, and the difference obtained can be determined as a reference time position. For example, if the receipt time position is subframe 9 in the n-th frame, and the time offset is 5 subframes, the reference time position can be determined as subframe 4 in the n-th frame. Therefore, the reference time information can be determined as the system time of the system frame (i.e., the n-th frame) at which subframe 4 in the n-th frame is located. For example, if the reference time information is SFN=1, it can be determined that the SFN of the system frame at which the receipt time position is located is 1.

In an embodiment, the time offset is carried in an m-th transmission of the signaling, where m is an integer greater than or equal to 1. The time offset can be carried not only in the above information, but also in the m-th transmission of the signaling. When m is equal to 1, the m-th transmission is a new transmission, and the time offset can be 0. When m is greater than 1, the m-th transmission is a retransmission, and the time offset can be greater than 0.

Furthermore, since the time offset is used to determine the reference time position, and the determination of the reference time position is due to the inconsistent understanding of the reference time information between the network side and the terminal side, which generally exists in the case of retransmission of signaling, the time offset can only be carried in the retransmission of signaling, and the time offset is not carried in the new transmission of signaling, which is beneficial for resource conservation.

In an embodiment, the time offset is carried in at least one of:

downlink control information (DCI);

media access control (MAC) subheader;

media access control control element (MAC CE);

PLC subheader;

RLC control packet;

packet data convergence protocol (PDCP) subheader; or

PDCP control packet.

Taking the DCI carrying the time offset as an example, the terminal receives the signaling according to the DCI scheduling, for example, the receipt time position of the signaling is subframe 1, the reference time information carried by the system information in the signaling is SFN=1, and the time offset carried by the DCI is 2 subframes. Accordingly, it can be calculated that the reference time position is subframe 9 of the previous system frame before the system frame at which the receipt time position is located. Therefore, it can be determined that the SFN of the previous system frame before the system frame at which the receipt time position is located is 1.

Taking the RLC subheader carrying the time offset as an example, the receipt time position of the signaling received by the terminal is subframe 1, the reference time information carried by the system information in the signaling is SFN=1, and the time offset carried by the RLC subheader is 12 subframes. Accordingly, it can be calculated that the reference time position is subframe 9 of the system frame of previous two before the system frame at which the receipt time position is located. Therefore, it can be determined that the SFN of the system frame of previous two before the system frame at which the receipt time position is located is 1.

In an embodiment, a transmission type corresponding to the signaling transmitted to the terminal includes at least one of:

hybrid automatic repeat request (HARQ) transmission;

radio link control (RLC) transmission; or

packet data convergence protocol (PDCP) transmission.

The network side device can retransmit signaling to the terminal, which can be a retransmission of HARQ, RLC, or PDCP.

In an embodiment, information carrying the reference time position includes undivided signaling carrying the reference time position.

The signaling carrying the reference time position may be divided into multiple packets when transmitted from higher to lower layers, for example, in the RLC layer, the signaling may be divided into multiple packets, where each packet contains only partial information of the reference time position, which may result in the information carrying the reference time position carrying only partial information of the reference time position.

Additionally, for a 10-bit SFN, the system information in the signaling may only carry a 6 bit Most Significant Bit (MSB) in the 10-bit SFN.

Both of the above cases can lead to inaccurate determination of the reference time position according to partial information of the reference time position. Therefore, information carrying the reference time position can be set to include undivided signaling (such as a complete 10-bit SFN) carrying the reference time position, such that a complete reference time position can be obtained from the information carrying the reference time position, and the reference time position can be accurately determined.

In an embodiment, the network side device transmits the signaling to the terminal multiple times, and transmission time positions of transmitting the signaling for the multiple times are in a same system frame.

In an embodiment, the terminal can determine the receipt time position of the received signaling as a reference time position, and the reference time information can be determined as the system time of the receipt time position.

In this case, the network side device transmits the signaling multiple times to the terminal, and the transmission time positions of the signaling for the multiple times are in the same system frame, such that the terminal receives the signaling transmitted by the network side multiple times, and receipt time positions of receiving the signaling for the multiple times are in a same system frame.

If the receipt time position of the signaling received for the multiple times is not in the same system frame, for example, taking two times as an example, if the receipt time positions for these two times are not in the same system frame, there may be a problem of determining the system time of one system frame as the system time of another system frame.

Therefore, by configuration to enable the terminal to receive the signaling transmitted multiple times by the network side, and to enable the receipt time positions of the signaling received multiple times to be in the same system frame, that is, to enable the network side device to transmit the signaling multiple times, but to enable each transmission to be in the same system frame, it can be ensured that the receipt time positions of the signaling received by the terminal every time are in the same system frame, without crossing system frames, thus avoiding the above problems.

In an embodiment, the receipt time position of the scheduling information of the signaling can be scheduled as the reference time position, and the reference time information can be determined as the system time of the receipt time position. For example, if the scheduling information is DCI, the receipt time location of receiving the DCI can be determined.

In this case, transmission carrying the signaling by the network side device is new transmission. Since the scheduling information and the new transmission are generally located in the same system frame, that is, for the new transmission, in this embodiment, the receipt time position of the scheduling information for scheduling the new transmission can be determined as the reference time position. Accordingly, it can be ensured that the receipt time position of scheduling information and the receipt time position of the new transmission are located in the same system frame, thus the receipt time position of scheduling information is determined as the reference time position, which is equivalent to determining the receipt time position of the new transmission as the reference time position, such that there will be no problems.

FIG. 14 is a schematic flowchart of a request transmitting method according to embodiments of the present disclosure. The request transmitting method shown in this embodiment can be performed by a network side device, which includes but is not limited to a network side device in a communication system such as 4G, 5G, or 6G communication system, etc., such as a base station, or a core network, etc. The network side device can communicate with the terminal. The terminal includes but is not limited to a communication device such as a mobile phone, a tablet, a wearable device, a sensor, or an Internet of Things (IoT) device.

As shown in FIG. 14, the request transmitting method may include the following step S1401.

In step S1401, a request is transmitted to a terminal for requesting the terminal to read reference time information in system information broadcasted by the network side device.

In an embodiment, when the network side device transmits system information to the terminal through signaling, the terminal may not receive the signaling, and the network side device retransmits the signaling. In this case, if the content of the first transmission of signaling is the same as the content of the retransmitted signaling, the reference time information in the first transmission of signaling is the same as the reference time information in the retransmitted signaling. For example, the SFN in the first transmission of signaling is the same as the SFN in the retransmitted signaling, and the H-SFN in the first transmission of signaling is the same as the H-SFN in the retransmitted signaling.

This can lead to inconsistent understanding between the network side device and the terminal regarding the system time carried in the system information. For example, the network side device may determine a receipt time position of the first transmission of signaling received by the terminal as a reference time position, but the terminal may determine a receipt time position of the current retransmitted signaling as a reference time position.

According to embodiments of the present disclosure, in a case where the network side device transmits system information to the terminal through signaling, the network side device may transmit a request to the terminal for requesting the terminal to receive the system information broadcasted by the network side device and read the reference time information in the system information. Since the system information broadcasted by the network side device is updated in real-time, there is not the case where the system information in the signaling is not updated during retransmission. Therefore, it is accurate to determine, according to the reference time information in the broadcasted system information, the system time information of the receipt time location of the system information. Accordingly, it can ensure the accurate determination of the system time information for the receipt time position, avoiding problems when the terminal uses the system time for subsequent operations.

For example, after receiving system information according to a request, the terminal can determine the receipt time position of the system information, and then determine the system time position as the reference time position associated with the reference time information, and then determine the reference time information as the system time of the reference time position. For example, if the reference time information is SFN=1, it can be determined that the SFN of the system frame at which the reference time position is located is 1.

Corresponding to the embodiments of the system time determining method, the time position indicating method, and the request transmitting method mentioned above, the present disclosure further provides embodiments of the system time determining device, the time position indicating device, and the request transmitting device.

The embodiments of the present disclosure provide a system time determining device, which can be applied to a terminal. The terminal includes but is not limited to a communication device such as a mobile phone, a tablet, a wearable device, a sensor, or an Internet of Things (IoT) device. The terminal can communicate with a network side device. The network side device includes but not limited to a network side device (such as a base station, a core network, etc.) in a communication system such as a 4G communication system, a 5G communication system, or a 6G communication system, etc.

In an embodiment, the system time determining device includes one or more processors configured to:

receive signaling transmitted by a network side device, where the signaling carries reference time information;

determine a reference time position associated with the reference time information; and

determine the reference time information as a system time of the reference time position.

In an embodiment, the reference time position is determined by a network side configuration or according to a protocol agreement.

In an embodiment, the reference time position corresponds to at least one relative time position, and the one or more processors are configured to:

determining a receipt time location of the signaling; and

according to a relative positional relationship between the at least one relative time position and the receipt time position, determining the reference time position in the at least one relative time position.

In an embodiment, the one or more processors are configured to determine a closest relative time position to the receipt time position in the at least one relative time position as the reference time position.

In an embodiment, the one or more processors are configured to determine a closest relative time position to the receipt time position in one or more of the at least one relative time position before the receipt time position as the reference time position.

In an embodiment, the one or more processors are configured to determine a closest relative time position to the receipt time position in one or more of the at least one relative time position after the receipt time position as the reference time position.

In an embodiment, the network side device transmits the signaling to the terminal n times, and the one or more processors are configured to:

determine a time offset between a time position of an i-th transmission of the signaling by the network side device and a time position of a j-th transmission of the signaling by the network side device, where i, j, and n are respectively integers, 1≤i≤n, 1≤j≤n, and i is greater than or equal to j; and

according to the time offset and the receipt time position of the reference time information, determine the reference time position.

In an embodiment, the time offset is carried in at least one of:

downlink control information (DCI);

media access control (MAC) subheader;

media access control control element (MAC CE);

PLC subheader;

RLC control packet;

packet data convergence protocol (PDCP) subheader; or

PDCP control packet.

In an embodiment, the time offset is carried in an m-th transmission of the signaling, where m is an integer greater than or equal to 1.

In an embodiment, a transmission type corresponding to the signaling transmitted by the network side device to the terminal includes at least one of:

hybrid automatic repeat request (HARQ) transmission;

radio link control (RLC) transmission; or

packet data convergence protocol (PDCP) transmission.

In an embodiment, information carrying the reference time position includes undivided signaling carrying the reference time position.

In an embodiment, the one or more processors are configured to determine a receipt time position of the signaling as the reference time position.

In an embodiment, the terminal receives the signaling transmitted by the network side multiple times, and receipt time positions of receiving the signaling for the multiple times are in a same system frame.

In an embodiment, the one or more processors are configured to:

determine a receipt time position of scheduling information of the signaling as the reference time position.

In an embodiment, transmission carrying the signaling by the network side device is new transmission.

The embodiments of the present disclosure further provide a system time determining device, including one or more processors configured to:

according to a request of a network side device, receive system information broadcasted by the network side device; and

according to the reference time information in the received system information, determine the system time information of the receipt time position of receiving the system information.

The embodiments of the present disclosure further provide a time position indicating device, which can be applied to a network side device. The network side devices includes but is not limited to a network side device in a communication system such as 4G, 5G, or 6G communication system, etc., such as a base station, or a core network, etc. The network side device can communicate with the terminal. The terminal includes but is not limited to a communication device such as a mobile phone, a tablet, a wearable device, a sensor, or an Internet of Things (IoT) device.

In an embodiment, the time position indicating device includes one or more processors configured to:

transmit signaling to a terminal, where the signaling carries reference time information; and

indicate a reference time position associated with the reference time information to the terminal.

In an embodiment, the network side device transmits the signaling to the terminal n times, and indicating the reference time position associated with the reference time information to the terminal includes:

indicating to the terminal a time offset between a time position of an i-th transmission of the signaling by the network side device and a time position of a j-th transmission of the signaling by the network side device, where i, j, and n are respectively integers, 1≤i≤n, 1≤j≤n, and i is greater than or equal to j.

In an embodiment, the time offset is carried in an m-th transmission of the signaling, where m is an integer greater than or equal to 1.

In an embodiment, the time offset is carried in at least one of:

downlink control information (DCI);

media access control (MAC) subheader;

media access control control element (MAC CE);

PLC subheader;

RLC control packet;

packet data convergence protocol (PDCP) subheader; or

PDCP control packet.

In an embodiment, a transmission type corresponding to the signaling transmitted to the terminal includes at least one of:

hybrid automatic repeat request (HARQ) transmission;

radio link control (RLC) transmission; or

packet data convergence protocol (PDCP) transmission.

In an embodiment, information carrying the reference time position includes undivided signaling carrying the reference time position.

In an embodiment, the network side device transmits the signaling to the terminal multiple times, and transmission time positions of transmitting the signaling for the multiple times are in a same system frame.

In an embodiment, transmission carrying the signaling by the network side device is new transmission.

The embodiments of the present disclosure further provide a request transmitting device, which can be applied to a network side device. The network side devices includes but is not limited to a network side device in a communication system such as 4G, 5G, or 6G communication system, etc., such as a base station, or a core network, etc. The network side device can communicate with the terminal. The terminal includes but is not limited to a communication device such as a mobile phone, a tablet, a wearable device, a sensor, or an Internet of Things (IOT) device.

In an embodiment, the request transmitting device includes one or more processors configured to:

transmit a request to a terminal for requesting the terminal to read reference time information in system information broadcasted by the network side device.

With regard to the device in the above examples, the specific manner in which the respective modules perform the operations has been described in detail in the examples of the related methods, and will not be explained in detail herein.

Since the device embodiments basically corresponds to the method embodiments, the relevant parts can refer to the partial description of the method embodiments. The device examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the examples. A person skilled in the art can understand and implement without creative work.

The embodiments of the present disclosure further provide a communication device, including: one or more processors; and one or more memories for storing a computer programs; where when the computer program is executed by the one or more processors, the system time determining method according to any one of embodiments mentioned above is implemented.

The embodiments of the present disclosure further provide a communication device, including: one or more processors; and one or more memories for storing a computer programs; where when the computer program is executed by the one or more processors, the time position indicating method according to any one of embodiments mentioned above and/or the request transmitting method according to any one of embodiments mentioned above is implemented.

The embodiments of the present disclosure further provide a computer-readable storage medium for storing a computer program is provided, where when the computer program is executed by one or more processors, the system time determining method according to any one of embodiments mentioned above is implemented.

The embodiments of the present disclosure further provide a computer-readable storage medium for storing a computer program is provided, where when the computer program is executed by one or more processors, the time position indicating method according to any one of embodiments mentioned above and/or the request transmitting method according to any one of embodiments mentioned above is implemented.

As shown in FIG. 15, FIG. 15 is a schematic block diagram of a time position indicating device and/or a request transmitting device 1500 according to embodiments of the present disclosure. The device 1500 may be provided as a base station. Referring to FIG. 15, the device 1500 includes a processing component 1522, a wireless transmitting/receiving component 1524, an antenna component 1526, and a signaling processing portion specific to a wireless interface. The processing component 1522 may further include one or more processors. One of the one or more processors in the processing component 1522 may be configured to implement a time position indicating method as described in any one of the above embodiments, and/or a request transmitting method as described in any one of the above embodiments.

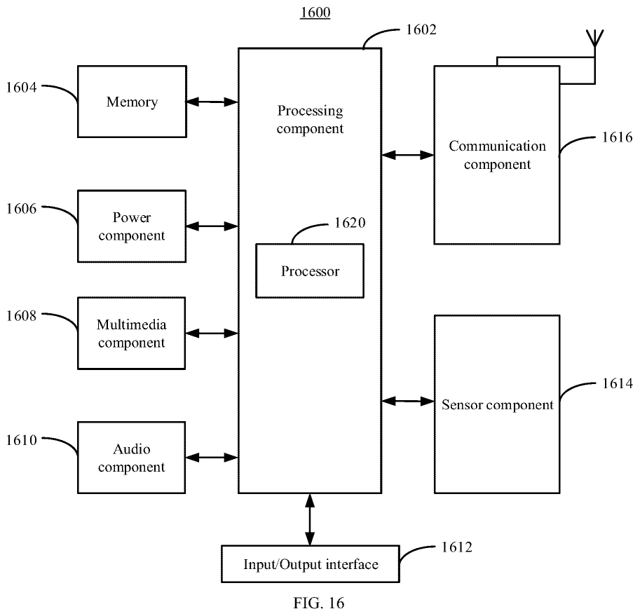

FIG. 16 is a schematic block diagram of a system time determining device 1600 according to embodiments of the present disclosure. For example, device 1600 can be a mobile phone, a computer, a digital broadcast terminal, a message transmitting and receiving device, a gaming console, a tablet device, a medical device, a fitness device, a personal digital assistant, and the like.

Referring to FIG. 16, device 1600 can include one or more of the following components: processing component 1602, memory 1604, power component 1606, multimedia component 1608, audio component 1610, input/output (I/O) interface 1612, sensor component 1614, or a communication component 1616.

The processing component 1602 generally controls the overall operations of the electronic device 1600, such as operations associated with display, calling, data communication, camera operation and recording operation. The processing assembly 1602 may include one or more processors 1620 to execute instructions to complete all or a part of the blocks of the above system time determining methods. Further, the processing component 1602 may include one or more modules to facilitate interaction between the processing component 1602 and another component. For example, the processing component 1602 may include a multimedia module to facilitate the interaction between the multimedia component 1608 and the processing component 1602.

The memory 1604 is configured to store different types of data to support the operations of the electronic device 1600. Examples of such data include instructions of any application program or method operable on the electronic device 1600, contact data, telephone directory data, messages, pictures, videos, and the like. The memory 1604 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 1606 provides power for different components of the electronic device 1600. The power supply component 1606 may include a power management system, one or more power sources, and other components associated with generating, managing and distributing power for the electronic device 1600.

The multimedia component 1608 may include a screen for providing an output interface between the electronic device 1600 and a user. In some examples, the screen may include a Liquid Crystal Display (LCD) and a Touch Panel (TP). If the screen includes a touch panel, the screen may be implemented as a touch screen for receiving an input signaling from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 1608 may include a front camera and/or a rear camera. When the device 1600 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 1610 is configured to output and/or input an audio signaling. For example, the audio component 1610 may include a microphone (MIC). When the electronic device 1600 is in an operating mode, such as a call mode, a recording mode and a speech recognition mode, the microphone is configured to receive an external audio signaling. The received audio signaling may be further stored in the memory 1604 or transmitted via the communication component 1616. In some examples, the audio component 1610 also includes a loudspeaker for outputting an audio signaling.

The I/O interface 1612 provides an interface between the processing component 1602 and a peripheral interface module which may be a keyboard, a click wheel, a button, or the like. These buttons may include but not limited to, a home button, a volume button, a start button and a lock button.

The sensor component 1614 may include one or more sensors for providing state assessments in different aspects for the electronic device 1600. For example, sensor component 1614 can detect an open/closed state of device 1600, a relative positioning of components, such as the display and keypad of device 1600, and sensor component 1614 can also detect a change in position of device 1600 or a component of device 1600, the presence or absence of user contact with device 1600, orientation or acceleration/deceleration of device 1600, and temperature change of device 1600. The sensor component 1614 may include a proximity sensor for detecting the existence of a nearby object without any physical touch. The sensor component 1614 may also include an optical sensor, such as a CMOS or CCD image sensor used in an imaging application. In some examples, the sensor component 1614 may also include an acceleration sensor, a gyro sensor, a magnetic sensor, a pressure sensor, or a temperature sensor.

The communication component 1616 is configured to facilitate wired or wireless communication between the electronic device 1600 and other devices. The device 1600 may access a wireless network according to a communication standard, such as WiFi, 2G, 3G, 4G LTE, 5G NR, or a combination thereof. In some embodiments, the communication component 1616 may receive a broadcast signaling or broadcast-related information from an external broadcast management system via a broadcast channel. In an example, the communication component 1616 may also include a Near Field Communication (NFC) module to facilitate short-range communications. For example, the NFC module may be implemented based on a radio frequency identification (RFID) technology, an infrared data association (IrDA) technology, an ultra-wide band (UWB) technology, a Bluetooth (BT) technology, and other technologies.

In an example, the apparatus 1600 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components for performing the system time determining method described above.

In an example, a non-transitory computer readable storage medium including instructions, such as the memory 1604 including instructions, is also provided. The above instructions may be executed by the processor 1620 of the apparatus 1600 to complete the system time determining method. For example, the non-transitory computer-readable storage medium may be a ROM, a RAM, a CD-ROM, a magnetic tape, a floppy disc, an optical data storage device, and the like.

After considering and practicing the disclosure of the specification, other embodiments of the present disclosure will be readily apparent to those skilled in the art. The present disclosure is intended to cover any modification, use or adaptation of the present disclosure. These modifications, uses or adaptations follow the general principles of the present disclosure and include common knowledge and conventional technical means in the technical field that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

It is to be noted that the relational terms such as “first” and “second” used herein are merely intended to distinguish one entity or operation from another entity or operation rather than to require or imply any such actual relation or order existing between these entities or operations. The term “including”, “containing” or any variation thereof is intended to encompass non-exclusive inclusion, so that a process, method, article or device including a series of elements includes not only those elements but also other elements not listed explicitly or those elements inherent to such a process, method, article or device. Without further limitation, the element defined by the statement “including a . . . ” do not preclude the existence of additional identical elements in the process, method, article, or device that include the element.

The above provides a detailed introduction to the methods and apparatuses provided in the embodiments of the present disclosure. Specific examples are applied in the present disclosure to explain the principles and embodiments of the present disclosure. The explanations of the above embodiments are only used to help understand the methods and core ideas of the present disclosure. Meanwhile, for those skilled in the art, based on the idea of the present disclosure, there will be changes in the embodiments and application scopes. In summary, the content of the specification should not be construed as limiting the present disclosure.

1. A system time determining method, performed by a terminal, comprising:
receiving signaling transmitted by a network side device, wherein the signaling carries reference time information;
determining a reference time position associated with the reference time information; and
determining the reference time information as a system time of the reference time position.

2. The method according to claim 1, wherein the reference time position is determined by a network side configuration or according to a protocol agreement, and/or a transmission type corresponding to the signaling transmitted by the network side device to the terminal comprises at least one of: hybrid automatic repeat request (HARQ) transmission; radio link control (RLC) transmission; or packet data convergence protocol (PDCP) transmission.

3. The method according to claim 1, wherein the reference time position corresponds to at least one relative time position, and determining the reference time position associated with the reference time information comprises:
determining a receipt time location of the signaling; and
according to a relative positional relationship between the at least one relative time position and the receipt time position, determining the reference time position in the at least one relative time position.

4. The method according to claim 3, wherein according to the relative positional relationship between the at least one relative time position and the receipt time position, determining the reference time position in the at least one relative time position comprises:
determining a closest relative time position to the receipt time position in the at least one relative time position as the reference time position.

5. The method according to claim 3, wherein according to the relative positional relationship between the at least one relative time position and the receipt time position, determining the reference time position in the at least one relative time position comprises:
determining a closest relative time position to the receipt time position in one or more of the at least one relative time position before the receipt time position as the reference time position; or
determining a closest relative time position to the receipt time position in one or more of the at least one relative time position after the receipt time position as the reference time position.

6. (canceled)

7. The method according to claim 1, wherein the network side device transmits the signaling to the terminal n times, and determining the reference time position associated with the reference time information comprises:
determining a time offset between a time position of an i-th transmission of the signaling by the network side device and a time position of a j-th transmission of the signaling by the network side device, wherein i, j, and n are respectively integers, 1≤i≤n, 1≤j≤n, and i is greater than or equal to j; and
according to the time offset and the receipt time position of the reference time information, determining the reference time position;
wherein the time offset is carried in at least one of: downlink control information (DCI); media access control (MAC) subheader; media access control control element (MAC CE); radio link control (RLC) subheader; RLC control packet; packet data convergence protocol (PDCP) subheader; or PDCP control packet.

8-10. (canceled)

11. The method according to claim 1, wherein information carrying the reference time position comprises undivided signaling carrying the reference time position.

12. The method according to claim 1, wherein determining the reference time position associated with the reference time information comprises:
determining a receipt time position of the signaling as the reference time position;
wherein transmission carrying the signaling by the network side device is new transmission.

13. The method according to claim 12, wherein the terminal receives the signaling transmitted by the network side multiple times, and receipt time positions of receiving the signaling for the multiple times are in a same system frame.

14. The method according to claim 1, wherein determining the reference time position associated with the reference time information comprises:
determining a receipt time position of scheduling information of the signaling as the reference time position;
wherein transmission carrying the signaling by the network side device is new transmission.

15. (canceled)

16. A system time determining method, performed by a terminal, comprising:
according to a request of a network side device, receiving system information broadcasted by the network side device, wherein the system information carries reference time information;
determining a receipt time position of the system information as a reference time position associated with the reference time information; and
determining the reference time information as a system time of the reference time position.

17. A time position indicating method, performed by a network side device, comprising:
transmitting signaling to a terminal, wherein the signaling carries reference time information; and
indicating a reference time position associated with the reference time information to the terminal.

18. The method according to claim 17, wherein the network side device transmits the signaling to the terminal n times, and indicating the reference time position associated with the reference time information to the terminal comprises:
indicating to the terminal a time offset between a time position of an i-th transmission of the signaling by the network side device and a time position of a j-th transmission of the signaling by the network side device, wherein i, j, and n are respectively integers, 1≤i≤n, 1≤j≤n, and i is greater than or equal to j;
wherein the time offset is carried in an m-th transmission of the signaling, wherein m is an integer greater than or equal to 1,
wherein the time offset is carried in at least one of: downlink control information (DCI); media access control (MAC) subheader; media access control control element (MAC CE); packet data convergence protocol (RLC) subheader; RLC control packet; packet data convergence protocol (PDCP) subheader; or PDCP control packet.

19-20. (canceled)

21. The method according to claim 17, wherein
a transmission type corresponding to the signaling transmitted to the terminal comprises at least one of: hybrid automatic repeat request (HARQ) transmission; radio link control (RLC) transmission; or packet data convergence protocol (PDCP) transmission; and/or
information carrying the reference time position comprises undivided signaling carrying the reference time position; and/or
the network side device transmits the signaling to the terminal multiple times, and transmission time positions of transmitting the signaling for the multiple times are in a same system frame; and/or
transmission carrying the signaling by the network side device is new transmission.

22-25. (canceled)

26. A system time determining device, comprising one or more processors configured to implement the method according to claim 1.

27. A system time determining device, comprising one or more processors configured to implement the method according to claim 16.

28. A time position indicating device, comprising one or more processors configured to implement the method according to claim 17.

29-31. (canceled)

32. A computer-readable storage medium for storing a computer program, wherein when the computer program is executed by one or more processors, the system time determining method according to claim 1 is implemented.

33. A computer-readable storage medium for storing a computer program, wherein when the computer program is executed by one or more processors, the time position indicating method according to claim 17 is implemented.

34. A computer-readable storage medium for storing a computer program, wherein when the computer program is executed by one or more processors, the time position indicating method according to claim 16 is implemented.
